(19) United States
(12) Patent Application Publication
(10) Pub. No.: US 2011/0177360 A1
(43) Pub. Date: Jul. 21, 2011

(54) METHOD OF PRODUCING PERPENDICULAR MAGNETIC RECORDING MEDIUM

(75) Inventor: Naoki TAKIZAWA, Nagano (JP)

(73) Assignee: Fuji Electric Device Technology Co., Ltd., Tokyo (JP)

(21) Appl. No.: 13/004,008

(22) Filed: Jan. 10, 2011

(30) Foreign Application Priority Data
Jan. 18, 2010 (JP) 2010-008159

(51) Int. Cl. G11B 5/66; B05D 5/12; G11B 5/65

(52) U.S. Cl. 428/829; 427/128; 428/836; 428/836.1

(57) ABSTRACT

A method of producing a perpendicular magnetic recording medium with a magnetic recording layer formed from ferromagnetic crystal grains and oxide-including non-magnetic crystal grain boundaries and provided on a non-magnetic substrate. The method is initiated by forming the magnetic recording layer by a reactive sputtering method using rare gas containing 2% by volume to 10% by volume (both inclusively) of oxygen gas at an initial stage of film formation. The method continues by successively forming the magnetic recording layer by reactive sputtering while reducing the concentration of the oxygen gas. The method may further include forming an undercoat layer of Ru or a Ru-alloy under the magnetic recording layer. In this manner, a granular magnetic layer having high characteristic coercive force (Hc) can be formed, while reducing the amount of expensive Pt or Ru required.

### BACKGROUND OF THE INVENTION

1. Field of the Invention

The present system and method relates to a perpendicular magnetic recording medium for a hard disk drive or similar storage medium, and a method of producing the same.

2. Description of the Background Art

The demand for recording density of magnetic recording medium used in hard disk drives or the like has continued to increase in recent years. The increase in coercive force of a magnetic thin film and the reduction in noise thereof are very important to satisfying a severe demand for increase of recording density. As a result, various magnetic layer compositions, structures, and materials and compositions of non-magnetic undercoat layers have been proposed.

In particular, there is a magnetic layer composition called “granular magnetic layer” having a structure in which ferromagnetic crystal grains are surrounded by non-magnetic, non-metallic substances such as oxides, nitrides, etc. Low noise characteristics are obtained by the granular magnetic layer because a grain boundary phase of the non-magnetic, non-metal substances separates ferromagnetic crystal grains physically. The result is that magnetic interaction between the ferromagnetic crystal grains is lowered to suppress formation of zigzag domain walls arising in transition regions of recording bits.

In a Cobalt-Chromium (CoCr) based metal magnetic layer which has been heretofore used, Cr is segregated from Co-based magnetic grains by film formation at a high temperature, so that Cr is precipitated into grain boundaries to thereby lower magnetic interaction between ferromagnetic grains. The granular magnetic layer has an advantage in that isolation of ferromagnetic grains can be accelerated relatively easily because non-magnetic, non-metallic substances used as the grain boundary phase are segregated easily compared with Cr.

In particular, the granular magnetic layer has an advantage in that a grain boundary phase is formed by segregation of non-magnetic, non-metallic substances such as oxide even in film formation without heating. This is in comparison with the case of the CoCr-based metal magnetic layer, in which increase of substrate temperature to 200° C. or higher at film formation is essential for sufficient segregation of Cr.

On the other hand, it is known that the grain boundary phase becomes so thick that ferromagnetic grains become small to reduce corrosion resistance when the amount of additives such as oxide is increased to form a grain boundary phase of the granular magnetic layer.

Therefore, JP-A-2006-120290 has proposed a technique in which when the granular magnetic layer is formed by a sputtering method, where the concentration of oxygen in sputtering gas is set to be high at an initial stage of the film formation and then reduced. This method controls the shape of ferromagnetic grains so that the diameter of ferromagnetic grains at a last stage of growth is larger than that at an initial stage of growth.

With respect to the amount of contained oxygen for formation of the magnetic recording layer on the intermediate layer, JP-A-2006-120290 discloses that when the oxygen content of an intermediate layer side portion of a magnetic recording layer is set to be high, the resulting grain size is made excessively fine. As a result, grains in the magnetic recording layer are undesirably formed on one grain in the intermediate layer. In each embodiment introduced in JP-A-2006-120290, the oxygen gas concentration of sputtering gas at an initial stage of film formation is not higher than 1%.

Although the perpendicular magnetic recording medium having a granular magnetic layer has various merits, it is necessary to add a great deal of expensive Platinum (Pt) or provide an expensive Ruthenium (Ru) undercoat layer as a thick film in order to obtain desired magnetic characteristics, especially to improve coercive force (Hc). This, however, becomes an issue with respect to production costs, because this runs counter to the trend towards low-price magnetic recording media. At the same time, it is necessary to control the granular magnetic layer with higher accuracy in order to attain reduction in medium noise.

### SUMMARY OF THE INVENTION

The present system and method is achieved in consideration of such a problem, and is accomplished based on a finding that high coercive force can be obtained when a sputtering gas having a specific oxygen concentration is used for forming a granular magnetic recording layer.

In accordance with one aspect of the invention, there is provided a method of producing a perpendicular magnetic recording medium which has a magnetic recording layer formed from ferromagnetic crystal grains and oxide-including non-magnetic crystal grain boundaries and provided on a non-magnetic substrate. The method includes forming the magnetic recording layer by a reactive sputtering method using rare gas containing 2% by volume to 10% by volume (both inclusive) of oxygen gas at an initial stage of film formation, and then successively forming the magnetic recording layer by a reactive sputtering method while reducing the concentration of the oxygen gas. The rare gas employed may be argon gas.

The method may further include forming an undercoat layer of Ru or a Ru-containing alloy just under the magnetic recording layer.

The method may further include forming a soft magnetic backing layer between the non-magnetic substrate and the magnetic recording layer.

With this method for forming a perpendicular magnetic recording layer, a magnetic recording medium having high coercive force Hc can be obtained when the oxygen gas concentration at an initial stage of film formation is set to be in a range of 2% by volume to 10% by volume, both inclusively. Accordingly, the amount of added expensive Pt can be reduced or an expensive Ru undercoat layer can be formed as a thin film, so that reductions in production costs can be attained.

In addition, a perpendicular magnetic recording medium having a high signal-to-noise ratio (SNR) and having excellent magnetic characteristics and excellent electromagnetic transducing characteristics can be obtained.

### BRIEF DESCRIPTION OF THE DRAWINGS

FIG. 1 is a sectional view showing an example of a magnetic recording medium for explaining a production method according to one aspect of the invention.

FIG. 2 is a graph for explaining change in the value of coercive force (Hc) versus the concentration of oxygen gas added to a sputtering gas.

FIG. 3 is a graph for explaining change in the value of signal-to-noise ratio (SNR) versus the concentration of oxygen gas added to a sputtering gas.

### DETAILED DESCRIPTION OF THE INVENTION

One or more embodiments of the present system and method will be described below in detail with reference to the drawings.

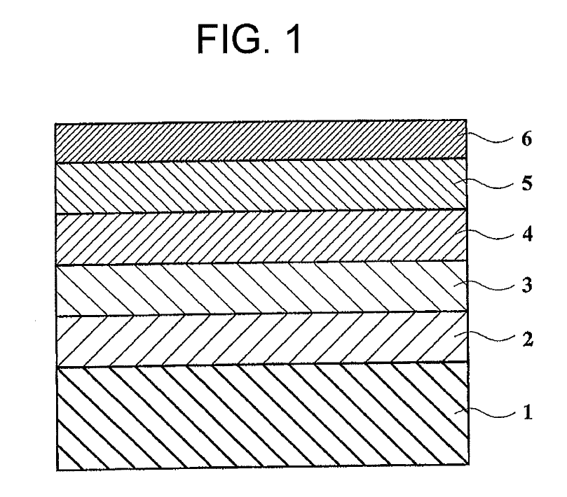

FIG. 1 schematically illustrates a sectional view showing an example of a perpendicular magnetic recording medium. The perpendicular magnetic recording medium has a structure in which a soft magnetic backing layer 2, a non-magnetic undercoat layer 3, a magnetic recording layer 4 and a protective layer 5 are formed successively on a non-magnetic substrate 1 and in which a liquid lubricant layer 6 is further formed thereon.

A granular magnetic layer having a structure in which ferromagnetic crystal grains are surrounded by non-magnetic, non-metallic substances of oxide is used as the magnetic recording layer 4. Preferably, a Cobalt-Platinum (CoPt) based alloy or a Cobalt-Chromium-Platinum (CoCrPt) based alloy is used as the ferromagnetic material. Further, at least one element selected from the group consisting of Tantalum (Ta), Boron (B), Niobium (Nb), Silver (Ag), Molybdenum (Mo), Tungsten (W), Palladium (Pd) and Copper (Cu) may added to the ferromagnetic material. A non-magnetic oxide, for example, Silicon Dioxide (SiO₂) may be used in a crystal grain boundary.

The magnetic recording layer 4 may be provided as a single layer, or may be provided as a multi-layer in which different materials are laminated.

The magnetic recording layer 4 is formed as a film by a reactive sputtering method using an oxygen gas-containing rare gas as a sputtering gas. At an initial stage of formation of the magnetic recording layer 4, the concentration of the contained oxygen gas is controlled to be in a range of 2% by volume to 10% by volume, both inclusively. Successively, formation of the magnetic recording layer is continued while the concentration of the oxygen gas is lowered, and is kept lower than the concentration at the initial stage of formation of the magnetic recording layer.

The initial stage of formation of the magnetic recording layer is a stage where 10% to 60% of the final film thickness of the magnetic recording layer is formed. If the film thickness ratio of the initial stage is smaller than 10%, it is undesirable that performance of an initial layer cannot be exerted. If the film thickness at the initial stage is larger than 60%, it is undesirable that a bad influence of the high-concentration oxygen gas occurs remarkably. When the magnetic recording layer is formed from laminated magnetic layers, the final film thickness means the sum of respective film thickness of the laminated magnetic layers.

Because the addition of the oxygen gas acts on formation of grain boundaries of magnetic crystal grains, and excessive addition disturbs growth of magnetic crystal grains, an optimal concentration of the contained oxygen gas exists. When the concentration of the contained oxygen gas is set to be in a range of 2% by volume to 10% by volume, both inclusively, the Hc of the magnetic recording layer can be improved. As a result, the amount of Pt as an expensive additive used to improve Hc can be reduced. Or an Ru undercoat layer, which generally needs to be sufficiently thick to improve Hc, can be provided as a thin film, so that the amount of expensive Ru used can be reduced. Consequently, reduction in production cost can be attained.

Nickel-Phosphorus (NiP) plated Aluminum (Al) alloy, reinforced glass, crystallized glass, etc. used for a general magnetic recording medium can be used as the non-magnetic substrate 1.

The soft magnetic backing layer 2 is a layer which may be formed to control magnetic flux from a magnetic head used for magnetic recording, to thereby improve recording/reproducing characteristics. The soft magnetic backing layer 2 may be dispensed with. A Nickel-Iron (NiFe) based alloy, a Sendust (FeSiAl) alloy, a high saturation flux density Iron-Cobalt (FeCo) alloy, etc. may be used as the soft magnetic backing layer 2. However, a better electromagnetic transducing characteristic may be obtained when an amorphous Cobalt alloy such as Cobalt-Niobium-Zirconium (CoNbZr) or Cobalt-Tantalum-Zirconium (CoTaZr), etc., is used.

Although the film thickness of the soft magnetic backing layer 2 may be set to be in a desired range in accordance with the characteristic of the magnetic head used for recording, in view of productivity the film thickness of the soft magnetic backing layer 2 may be set in a range of 5 nm to 100 nm, both inclusively.

A magnetic domain control layer can be provided under the soft magnetic backing layer for the purpose of controlling a magnetic domain of the soft magnetic backing layer 2.

The non-magnetic undercoat layer 3 is used for suitably controlling the crystal orientation, crystal grain size and grain boundary segregation of the magnetic recording layer 4. A film of Ruthenium (Ru) or an alloy containing at least Ru such as RuCr, RuCo, RuSi, RuW, RuTi, RuB, etc. is used as the material of the non-magnetic undercoat layer 3.

It is necessary in view of recording that the film thickness of the non-magnetic undercoat layer 3 is a required minimum film thickness to control the structure of the magnetic recording layer 4. In addition, when a film of a Nickel (Ni) based alloy such as NiFe, NiFeNb, NiFeSi, NiFeB, NiFeCr, NiFeNbB, etc. is formed as a layer under the non-magnetic undercoat layer 3, crystallinity and orientation of the non-magnetic undercoat layer 3 can be improved.

A non-magnetic seed layer may be provided between the soft magnetic backing layer 2 and the non-magnetic undercoat layer 3 for the purpose of controlling the crystal orientation and structure of the non-magnetic undercoat layer 3 or the granular magnetic layer 4.

A protective film generally used in this field may be used as the protective layer 5. For example, a protective film containing carbon as a main component may be used.

A liquid lubricant generally used in this field may be used as the liquid lubricant layer 6. For example, a perfluoro polyether-based lubricant can be used.

### Example

The present method will be described below more in detail based on an example. The following example is only a representative example for explaining the method suitably but is not intended to limit the method.

### Experimental Example 1

A chemically reinforced glass substrate (e.g. N-5 glass substrate made by HOYA Corporation) having a smooth surface was used as a non-magnetic substrate 1. The non-magnetic substrate 1 was washed and then introduced into a sputtering apparatus, and a target containing 85 atomic % of Co, 10 atomic % of Zr and 5 atomic % of Nb was used so that a soft magnetic backing layer 2 of CoZrNb was formed as a 100 nm-thick film on the non-magnetic substrate 1 by a DC magnetron sputtering method under an atmosphere of Ar gas pressure of 5 mTorr. Successively, a target containing 83 atomic % of Ni, 15 atomic % of Fe and 2 atomic % of Cr which was a non-magnetic Ni-based alloy was used so that a NiFeCr seed layer was formed as a 10 nm-thick film under an atmosphere of Ar gas pressure of 5 mTorr. Successively, a Ru target was used so that a Ru undercoat layer 3 was formed as a 15 nm-thick film under an atmosphere of Ar gas pressure of 30 mTorr. Successively, a target containing 92 mol % of CoCrPt (75 atomic % of Co, 10 atomic % of Cr and 15 atomic % of Pt) and 8 mol % of SiO₂ was used so that a CoCrPt—SiO₂ magnetic recording layer 4 was formed. The amount of oxygen gas added to the sputtering gas for forming a 10 nm-thick initial layer was changed variously. Specifically, film formation was performed under a condition that 0% by volume to 14% by volume of oxygen gas was added to the Ar partial pressure. A 10 nm-thick surface layer was formed under a condition of pure Ar gas. Finally, a carbon target was used so that a protective layer 5 of carbon was formed as a 4 nm-thick film. Then, the resulting recording medium was taken out from a vacuum apparatus. Then, a liquid lubricant layer 6 of perfluoro polyether was formed as a 1.5 nm-thick film by a dipping method. Thus, a perpendicular magnetic recording medium was obtained.

### Comparative Example 1

Comparative Example 1 is an example in which the timing of addition of oxygen gas was changed. A perpendicular magnetic recording medium was produced in the same manner as in Experimental Example 1 except that the 10 nm-thick initial layer in film formation for the CoCrPt—SiO₂ magnetic recording layer 4 was formed under a condition of pure Ar gas and the 10 nm-thick surface layer was formed under a condition that 0% by volume to 14% by volume of oxygen gas was added to Ar.

### Comparative Example 2

Comparative Example 2 is an example in which the oxygen gas concentration was kept constant during film formation. A perpendicular magnetic recording medium was produced in the same manner as in Experimental Example 1 except that all layers in film formation for the CoCrPt—SiO₂ magnetic recording layer 4 were formed under a condition that 0% by volume to 14% by volume of oxygen gas was added to Ar.

(Evaluation)

Coercive forces (Hc) of samples produced by Experimental Example 1 and Comparative Examples 1 and 2 were measured with a Kerr effect measuring apparatus. Signal-to-noise ratios (SNR) were further measured with a spin stand tester to which a single pole type magnetic head for perpendicular magnetic recording medium was attached.

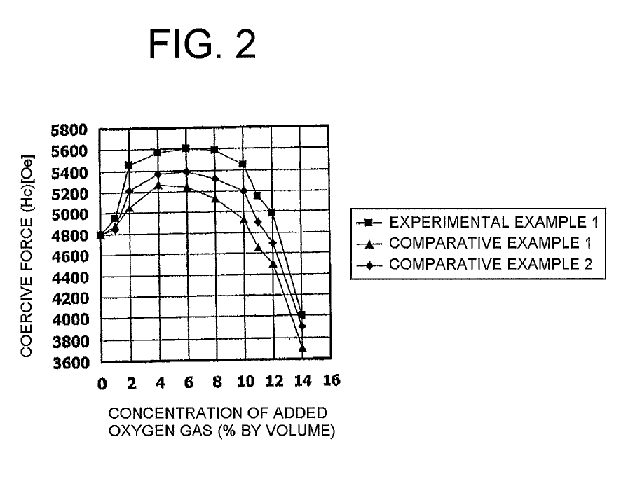

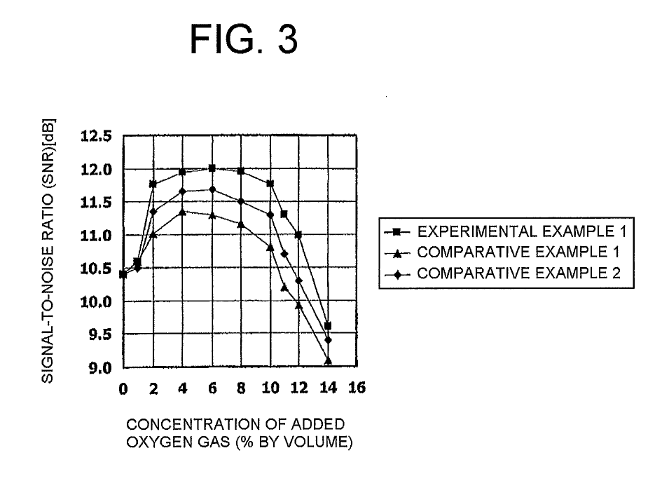

Results are shown in FIGS. 2 and 3. The ascending order of the Hc and the SNR of the samples was Comparative Example 1<Comparative Example 2<Experimental Example 1. Addition of oxygen gas to the initial layer portion of the magnetic recording layer exhibited a good result. In addition, a range of 2% to 10% was good as the concentration of added oxygen gas. If the oxygen gas concentration is 1% or lower or 11% or higher, the Hc and the SNR deteriorate.

What is claimed is:

1. A method of producing a perpendicular magnetic recording medium on a non-magnetic substrate, comprising:
initiating a reactive sputtering method for the formation of a magnetic recording layer on the non-magnetic substrate, wherein:
during an initial stage the reactive sputtering method comprises sputtering using a gas combination of a rare gas and oxygen gas, the gas combination comprising 2% to 10% by volume inclusively of the oxygen gas;
and
completing the formation of the magnetic recording layer by continuing the reactive sputtering method using the gas combination while reducing the concentration of the oxygen gas as a percentage by volume of the gas combination;
whereby the magnetic recording layer formed on the non-magnetic substrate comprises ferromagnetic crystal grains and oxide-including non-magnetic crystal grain boundaries.

2. The method of producing a perpendicular magnetic recoding medium of claim 1, wherein the rare gas comprises argon gas.

3. The method of producing a perpendicular magnetic recoding medium of claim 1, further comprising forming an undercoat layer of Ruthenium (Ru) or a Ru-containing alloy immediately under the magnetic recording layer.

4. The method of producing a perpendicular magnetic recording medium of claim 1, further comprising forming a soft magnetic backing layer between the non-magnetic substrate and the magnetic recording layer.

5. The method of producing a perpendicular magnetic recording medium of claim 1, wherein the initial stage of the sputtering method comprises a stage where between 10% and 60% inclusive of the final film thickness of the magnetic recording layer is formed.

6. The method of producing a perpendicular magnetic recording medium of claim 5, wherein:
the magnetic recording layer is formed from laminated magnetic layers; and
the final film thickness is the sum of the respective film thicknesses of the laminated magnetic layers.

7. The method of producing a perpendicular magnetic recording medium of claim 1, wherein the magnetic recording layer comprises at least one of a Cobalt-Platinum (CoPt) based alloy or a Cobalt-Chromium-Platinum (CoCrPt) based alloy.

8. The method of producing a perpendicular magnetic recording medium of claim 7, wherein the magnetic recording layer further comprises at least one of Tantalum (Ta), Boron (B), Niobium (Nb), Silver (Ag), Molybdenum (Mo), Tungsten (W), Palladium (Pd) or Copper (Cu).

9. A perpendicular magnetic recording medium, comprising:
a non-magnetic substrate; and
a magnetic recording layer produced on the non-magnetic substrate, wherein the magnetic recording layer is produced by a process of initiating a reactive sputtering method for the formation of the magnetic recording layer on the non-magnetic substrate, wherein:
during an initial stage the reactive sputtering method comprises sputtering using a gas combination of a rare gas and oxygen gas, the gas combination comprising 2% to 10% by volume inclusively of the oxygen gas;
and
completing the formation of the magnetic recording layer by continuing the reactive sputtering method using the gas combination while reducing the concentration of the oxygen gas as a percentage by volume of the gas combination;
whereby the magnetic recording layer formed on the non-magnetic substrate comprises ferromagnetic crystal grains and oxide-including non-magnetic crystal grain boundaries.

10. The perpendicular magnetic recording medium of claim 9, further comprising an undercoat layer of Ruthenium (Ru) or a Ru-containing alloy immediately under the magnetic recording layer.

11. The perpendicular magnetic recording medium of claim 9, further comprising a soft magnetic backing layer between the non-magnetic substrate and the magnetic recording layer.

12. The perpendicular magnetic recording medium of claim 9, wherein the initial stage of the sputtering method forming the magnetic recording layer comprises a stage where between 10% and 60% inclusive of the final film thickness of the magnetic recording layer is formed.

13. The perpendicular magnetic recording medium of claim 12, wherein:
the magnetic recording layer comprises laminated magnetic layers; and
the final film thickness is the sum of the respective film thicknesses of the laminated magnetic layers.

14. The perpendicular magnetic recording medium of claim 9, wherein the magnetic recording layer comprises at least one of a Cobalt-Platinum (CoPt) based alloy or a Cobalt-Chromium-Platinum (CoCrPt) based alloy.

15. The magnetic recording medium of claim 14, wherein the magnetic recording layer further comprises at least one of Tantalum (Ta), Boron (B), Niobium (Nb), Silver (Ag), Molybdenum (Mo), Tungsten (W), Palladium (Pd) or Copper (Cu).
